(19) United States
(12) Patent Application Publication
(10) Pub. No.: US 2006/0160974 A1
(43) Pub. Date: Jul. 20, 2006

(54) Novel polyvinyl esters

(76) Inventors: Jorg Ludwig Schulte, Frankfurt (DE); Jorg Schottek, Frankfurt (DE); Tim Dickner, Frankfurt (DE); Werner Wiltschka, Frankfurt (DE)

Correspondence Address: STERNE, KESSLER, GOLDSTEIN & FOX PLLC, 1100 NEW YORK AVENUE, N.W., WASHINGTON, DC, 20005, US

(21) Appl. No.: 10/525,078

(22) PCT Filed: Aug. 14, 2003
(86) PCT No.: PCT/EP03/09016

§ 371 Date: Aug. 25, 2005

(30) Foreign Application Priority Data
Aug. 23, 2002 (DE) 102 38 659.5

(51) Int. Cl. C08F 218/02

(52) U.S. Cl. 526/330

(57) ABSTRACT

The present invention relates to polymers having specific geometries based on polyvinyl esters, to initiator systems for their preparation and to a process for preparing polymers which have specific geometries and are based on polyvinyl esters.

The present invention relates to polymers which have specific geometries and are based on polyvinyl esters and to a process for preparing polymers which have specific geometries and are based on polyvinyl esters.

Polyvinyl esters are polymers which are obtainable from vinyl esters and have the 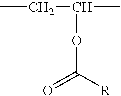
moiety as the basic monomer of the macromolecules. Among these, the polyvinyl acetates (R═CH₃) have by far the greatest industrial significance.

Polyvinyl acetate is an important thermoplastic polymer and is used, inter alia, as an adhesive (component), lacquer raw material, for packaging films, for the coating of paper and foods (sausage and cheese coatings), as an additive for concrete and as a raw material for the preparation of polyvinyl alcohols and polyvinyl acetals (Römpp Lexikon Chemie—Version 2.0, Stuttgart/New York: Georg Thieme Verlag 1999).

In industry, polyvinyl acetate is prepared by free-radical polymerizations, and the polymerization may be carried out in solution, in bulk and in emulsion. The free-radical initiators used are predominantly azoisobutyronitrile and dibenzoyl peroxide (AIBN/BPO). Since these free-radical polymerizations proceed in a rapid and uncontrolled manner, stereo-differentiation is ruled out and control of the molecular weight and of the molecular weight distribution is possible only with difficulty (W. Daniels in: Kirk-Othmer Encycl. Chem. Technol., 3^{rd} Ed. 1983, 23, 817-847).

Owing to the restriction to a free-radical polymerization of vinyl acetate, it has hitherto not been possible to synthesize polyvinyl acetates having specific geometries, for example star-, comb- or ladder-shaped polyvinyl acetate having a narrow molecular weight distribution. Polymers which have these specific geometries and are based on other monomers find uses, for example, in the production of fibers, films and moldings, as gel formers, as a rubber, for the controlled release of active ingredients, as liquid crystals and as high-performance plastics for microelectronic materials. Polyvinyl acetates having the specific geometries and a narrow molecular weight distribution have not yet been described.

One means of controlled polymerization and of controlling some polymer properties consists in what is known as “ATRP” (atom transfer radical polymerization) of monomers, which may be carried out under metal catalysis (WO9630421). In this method, a redox reaction of a metal with an initiator reversibly forms a radical which can incorporate a monomer to form a new radical. In the ideal case, the newly formed radical is again in equilibrium with the metal by a redox reaction. This control provides defined polymers having narrow molecular weight distributions and a defined molecular weight (K. Matyjaszewski, J. Xia, Chem. Rev. 2001; 101 (12), 2921-2990).

Owing to the small atom transfer equilibrium constants, the controlled polymerization of vinyl acetate by means of ATRP still today constitutes a challenge (J. Xia, H.-J. Paik, K. Matyjszewski, Macromolecules 1999, 32, 8310-8314). The literature describes only one example of a possible controlled free-radical polymerization of vinyl acetate (M. Wakioka, K.-Y. Baek, T. Ando, M. Kamigaito, M. Sawamoto, Macromolecules 2002, 35, 330-333).

It is thus an object of the invention to develop initiator systems which avoid the described disadvantage of the prior art and lead to novel polymers which have specific geometries and are based on polyvinyl esters.

It has now been found that, surprisingly, the use of novel initiator systems which have at least two active centers enables the synthesis of novel polyvinyl esters having specific geometries.

The present invention provides initiator systems for preparing polyvinyl esters, comprising at least one compound of the formula I, at least one metal compound of the formula II and optionally at least one additive of the formula III: 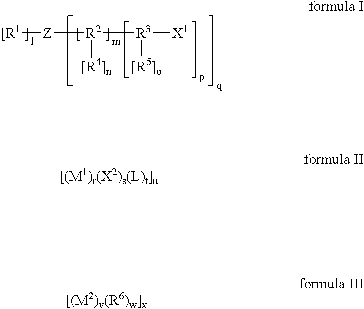
Z is a central atom and is an atom of group 13 to 16 of the Periodic Table of the Elements, preferably carbon, silicon, nitrogen, phosphorus, oxygen or sulfur, more preferably carbon or silicon, and
X¹ is in each case the same or different and is a halogen atom, preferably fluorine, chlorine, bromine or iodine, more preferably chlorine, bromine or iodine, and
R¹ is the same or different and is hydrogen or a C₁-C₂₀ group, and
R² is the same or different and is a bridging C₁-C₂₀ group between the central atom Z and the initiating [R³—X¹] unit or silicon or oxygen, and
R³ is the same or different and is carbon or silicon, and
R⁴ is the same or different and is a hydrogen atom or a C₁-C₂₀ group, and
R⁵ is the same or different and is hydrogen or a C₁-C₂₀ group,
l is a natural integer and is zero, 1, 2 or 3, and
m is in each case the same or different and is a natural integer and is zero, 1, 2, 3, 4 and 5, and
n is in each case the same or different and is a natural integer and is zero, 1, 2, 3, 4, 5, 6, 7, 8, 9, 10, 11, 12, 13, 14, 15, 16, 17, 18, 19 and 20, and
o is in each case the same or different and is 1 or 2, and
p is in each case the same or different and is a natural integer and is 1, 2, 3, 4 and 5, and
q is a natural integer and is 2, 3 or 4, and
M¹ is in each case the same or different and is a transition metal of group 3 to 12 of the Periodic Table of the Elements, preferably chromium, molybdenum, ruthenium, iron, rhodium, nickel, palladium or copper, more preferably iron or ruthenium, and
X² is in each case the same or different and is oxygen or a halogen atom, more preferably fluorine, chlorine, bromine or iodine, and
L is in each case the same or different and is a ligand, preferably a carbon ligand, for example methyl, phenyl, cymene, cumene, tolyl, mesityl, xylyl, indenyl benzylidene, cyclopentadienyl or carbonyl, a nitrogen ligand, for example triethylamine, tetramethylethylene-diamine, pyridine, 2,2′-bipyridyl, substituted 2,2′-bipyridyl, 1,10-phenanthroline, phenylpyridin-2-ylmethylenamine, acetonitrile, substituted imidazolidine or terpyridyl, a phosphorus ligand, for example triphenyl-phosphine, tricyclohexylphosphine, bis(diphenylphosphino)-ethane, bis(diphenylphosphino)propane or BINAP, and
r is in each case the same or different and is a natural integer and is 1, 2, 3, 4 and 5, and
s is in each case the same or different and is a natural integer and is zero, 1, 2, 3, 4 and 5, and
t is in each case the same or different and is a natural integer and is zero, 1, 2, 3, 4 and 5, and
u is a natural integer and is 1, 2, 3, 4 and 5, and
M² is the same or different and is an element of group 1 to 15 of the Periodic Table of the Elements, more preferably Li, Mg, Ti, B, Al, P or N, and
R⁶ is the same or different and is hydrogen, a halogen atom or a C₁-C₂₀ group, more preferably methoxy, ethoxy, n-propoxy or i-propoxy, and
v is the same or different and is a natural integer and is 1, 2, 3, 4, 5, 6, 7 and 8, and
w is the same or different and is a natural integer and is 1, 2, 3, 4, 5, 6, 7 and 8, and
x is a natural integer and is 1, 2, 3, 4, 5, 6, 7 and 8.

In the context of the present invention, a C₁-C₂₀ group refers preferably to the C₁-C₂₀-alkyl radicals, more preferably methyl, ethyl, n-propyl, i-propyl, n-butyl, i-butyl, s-butyl, t-butyl, n-pentyl, s-pentyl, cyclopentyl, n-hexyl, cyclohexyl, n-octyl or cyclooctyl, C₁-C₂₀-alkenyl, more preferably ethenyl, propenyl, butenyl, pentenyl, cyclopentenyl, hexenyl, cyclo-hexenyl, octenyl or cyclooctenyl, C₁-C₂₀-alkynyl, more preferably ethynyl, propynyl, butynyl, pentynyl, hexynyl or octynyl, C₆-C₂₀-aryl, more preferably phenyl, biphenyl, naphthyl or anthracenyl, C₁-C₂₀-fluoroalkyl, more preferably trifluoro-methyl, pentafluoroethyl or 2,2,2-trifluoroethyl, C₆-C₂₀-aryl, more preferably phenyl, biphenyl, naphthyl, anthracenyl, triphenylenyl, [1,1′; 3′,1″]terphenyl-2′-yl, binaphthyl or phenanthrenyl, C₆-C₂₀-fluoroaryl, more preferably tetrafluoro-phenyl or heptafluoronaphthyl, C₁-C₂₀-alkoxy, more preferably methoxy, ethoxy, n-propoxy, i-propoxy, n-butoxy, i-butoxy, s-butoxy or t-butoxy, C₆-C₂₀-aryloxy, more preferably phenoxy, naphthoxy, biphenyloxy, anthracenyloxy, phenanthrenyloxy, C₇-C₂₀-arylalkyl, more preferably o-tolyl, m-tolyl, p-tolyl, 2,6-dimethylphenyl, 2,6-diethylphenyl, 2,6-di-i-propylphenyl, 2,6-di-t-butylphenyl, o-t-butylphenyl, m-t-butylphenyl, p-t-butylphenyl, C₇-C₂₀-alkylaryl, more preferably benzyl, ethyl-phenyl, propylphenyl, diphenylmethyl, triphenylmethyl or naphthalenylmethyl, C₇-C₂₀-aryloxyalkyl, more preferably o-methoxyphenyl, m-phenoxymethyl, p-phenoxymethyl, C₁₂-C₂₀-aryloxyaryl, more preferably p-phenoxyphenyl, C₅-C₂₀-heteroaryl, more preferably 2-pyridyl, 3-pyridyl, 4-pyridyl, quinolinyl, isoquinolinyl, acridinyl, benzoquinolinyl or benzoisoquinolinyl, C₄-C₂₀-heterocycloalkyl, more preferably furyl, benzofuryl, 2-pyrolidinyl, 2-indolyl, 3-indolyl, 2,3-dihydro-indolyl, C₈-C₂₀-arylalkenyl, more preferably o-vinylphenyl, m-vinylphenyl, p-vinylphenyl, C₈-C₂₀-arylalkynyl, more preferably o-ethynylphenyl, m-ethynylphenyl or p-ethynylphenyl, C₂-C₂₀ heteroatom-containing group, more preferably carbonyl, benzoyl, oxybenzoyl, benzoyloxy, acetyl, acetoxy or nitrile, and one or more C₁-C₂₀ groups may form a cyclic system.

In the context of the present invention, a bridging C₁-C₂₀ group refers preferably to C₁-C₂₀-alkyl, more preferably methylene, ethylene, propylene, butylene, pentylene, cyclo-pentylene, hexylene or cyclohexylene, C₁-C₂₀-alkenyl, more preferably ethenyl, propenyl, butenyl, pentenyl, cyclo-pentenyl, hexenyl or cyclohexenyl, C₁-C₂₀-alkynyl, more preferably ethynyl, propynyl, butynyl, pentynyl or hexynyl, C₁-C₂₀-aryl, more preferably o-phenylene, m-phenylene or p-phenylene, C₁-C₂₀ heteroatom-containing group, more preferably carbonyl, oxycarbonyl, carbonyloxy, carbamoyl or amido.

Illustrative examples, which do not, however, restrict the invention, of compounds of the formula I are:

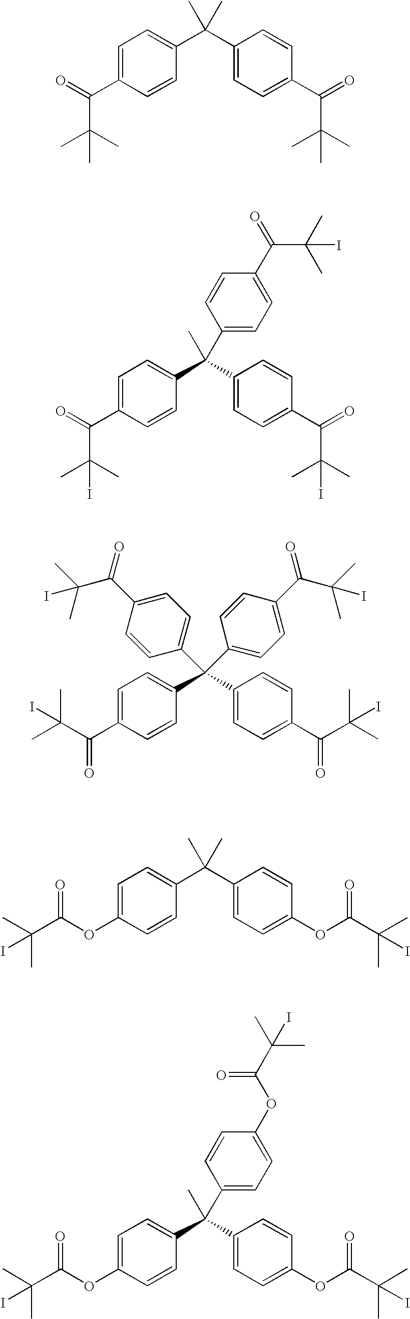

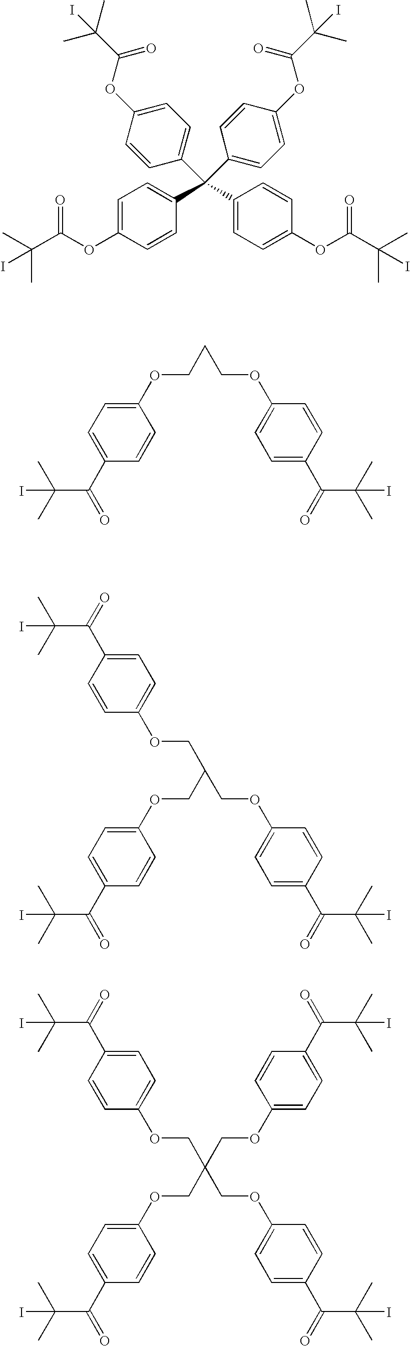

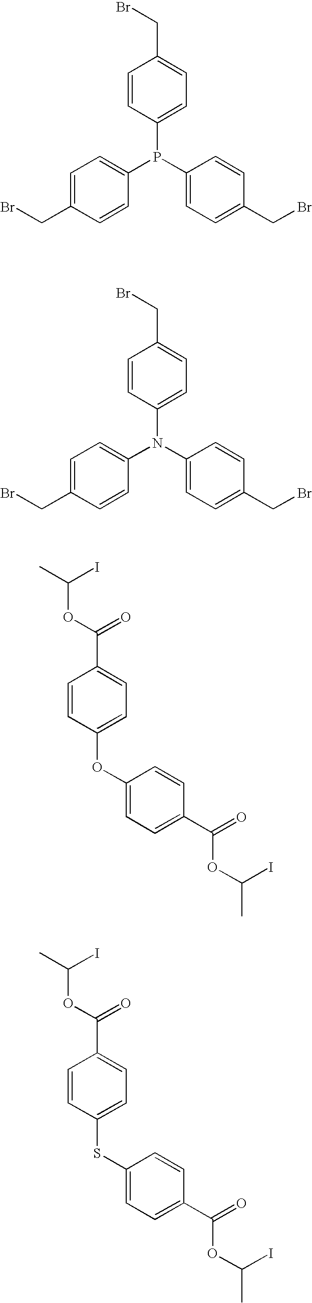

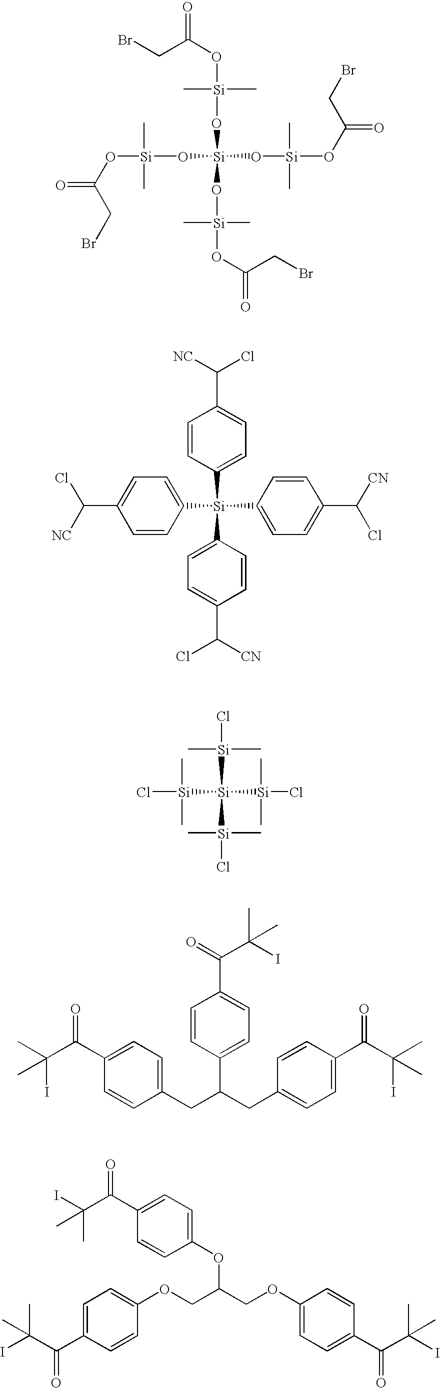

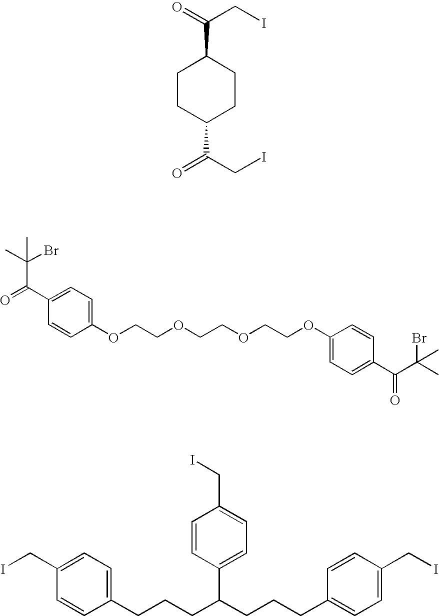

Illustrative examples, which do not, however, restrict the invention of compounds of the formula II are:

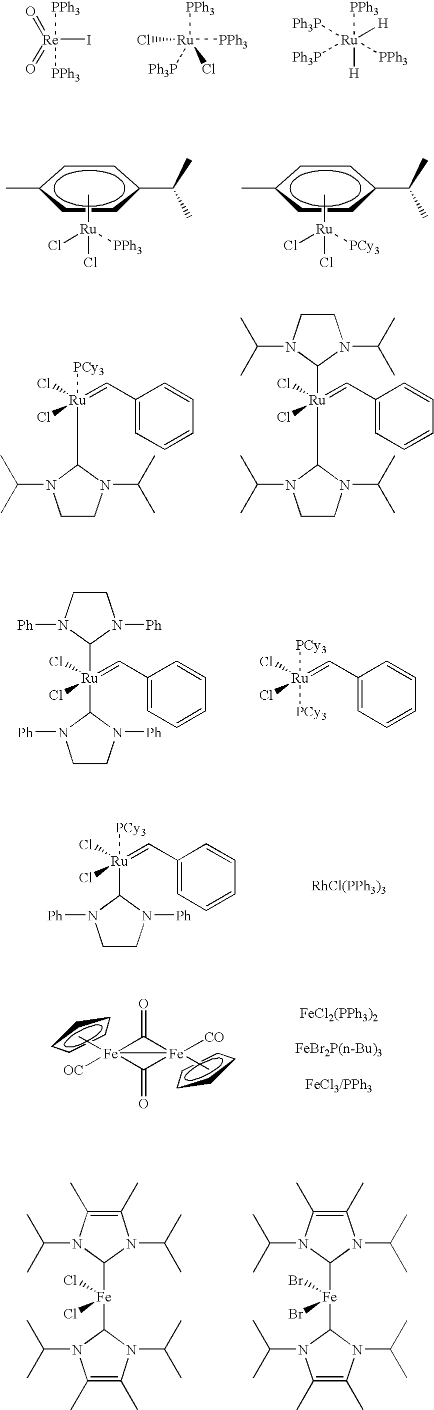

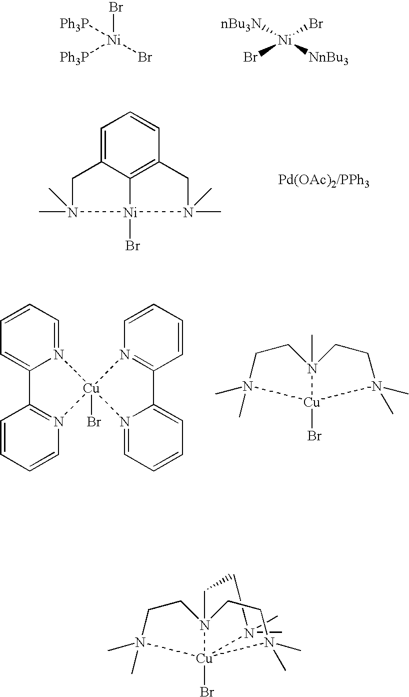

Illustrative examples which do not, however, restrict the invention, of additives of the formula III are:
Al(OMe)₃; Al(OEt)₃; Al(O-nPr)₃, Al(O-iPr)₃, Al(O-nBu)₃; Al(O-sBu)₃; Al(O-tBu)₃; MeAl(O-2,6-di-tbutylphenyl)₂; Al(OPh)₃; Ti(OMe)₄; Ti(OEt)₄; Ti(O-nPr)₄; Ti(O-iPr)₄; Ti(O-nBu)₄; Ti(O-sBu)₄; Ti(O-tBu)₄; LiOMe; LiOEt; LiO-nPr; LiO-iPr; LiO-nBu; LiO-sBu; LiO-tBu; B(OMe)₃; B(OEt)₃; B(O-nPr)₃; B(O-iPr)₃; B(O-nBu)₃; B(O-sBu)₃; B(O-tBu)₃; PPh₃; P-tBu₃; Et₃N; nBu₂NH.

In this list, the abbreviations mean: Me=methyl, Et=ethyl, nPr=n-propyl, iPr=isopropyl, nBu=n-butyl, sBu=sec-butyl, tBu=tert-butyl and Ph=phenyl.

The invention further provides initiator systems for preparing polyvinyl esters, consisting of a compound of the formula IV and a metal compound of the formula II and optionally an additive of the formula III: 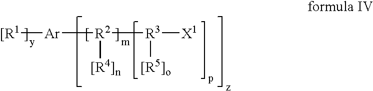
where
Ar is an aromatic basic structure having at least four carbon atoms, in which one or more carbon atoms may be exchanged for boron, nitrogen or phosphorus, preferred aromatic or heteroaromatic basic structures being derived from benzene, biphenyl, naphthalene, anthracene, phen-anthrene, triphenylene, quinoline, pyridine, bipyridine, pyridazine, pyrimidine, pyrazine, triazine, benzopyrrole, benzotriazole, benzopyridine, benzopyrazidine, benzopyrimidine, benzopyrazine, benzotriazine, indolizine, quinolizine, carbazole, acridine, phenazine, benzoquinoline, phenoxazine, each of which may also optionally be substituted, and
R¹, R², R³, R⁴, R⁵ are each as defined above, and
m, n, o, p are each as defined above, and
X¹ is as defined above, and
y is a natural integer and is zero, 1, 2, 3, 4, 5, 6, 7, 8, 9, 10, 11, 12, 13, 14, 15, 16, 17, 18, 19 and 20, and
z is a natural integer and is 2, 3, 4, 5, 6, 7, 8, 9 and 10.

Illustrative examples, which do not, however, restrict the invention, of compounds of the formula IV are:

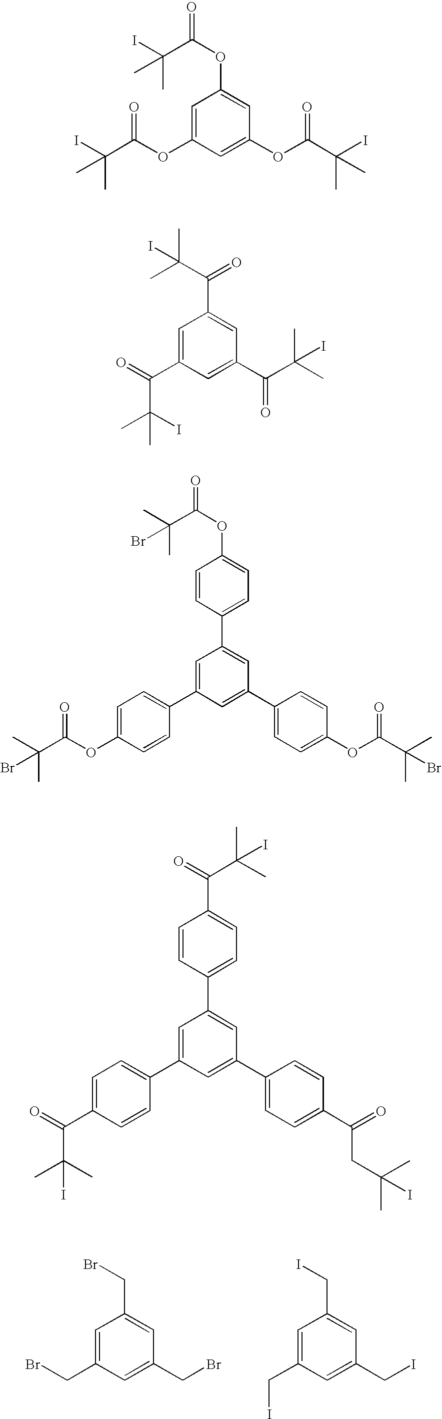

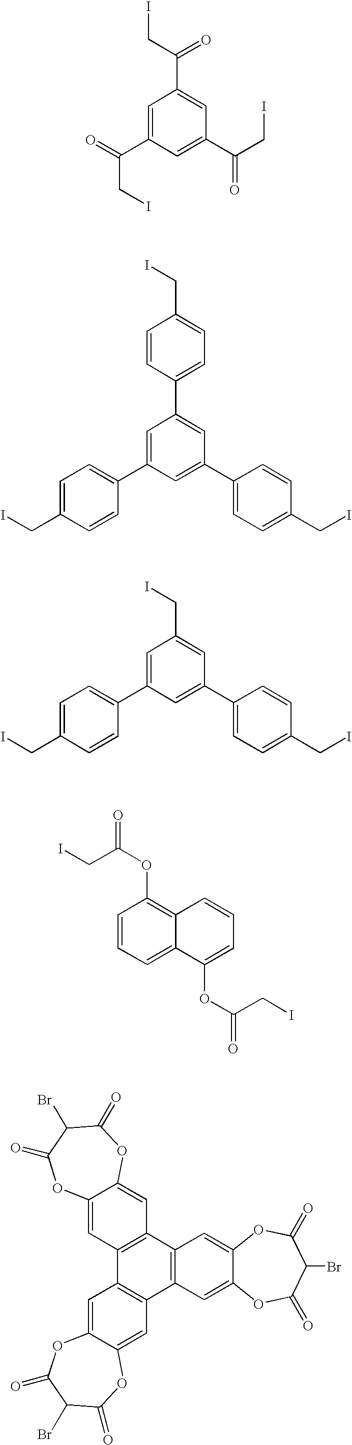

The invention further provides initiator systems for preparing polyvinyl esters, consisting of a compound of the formula V and a metal compound of the formula II and optionally an additive of the formula III: 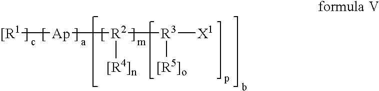
where
Ap is a cyclic nonaromatic basic structure having at least three carbon atoms which may also contain heteroatoms such as nitrogen, boron, phosphorus, oxygen or sulfur, preferred aliphatic basic structures being derivable from the group of cycloalkyl, for example cyclopropyl, cyclobutyl, cyclopentyl, cyclohexyl, cycloheptyl, cyclooctyl, cyclononyl, or from the cycloheteralkyl group, for example aziridine, azetidine, pyrrolidine, piperidine, azepane, azocane, 1,3,5-triazinane, 1,3,5-trioxane, oxetane, furan, dihydrofuran, Tetrahydrofuran, pyran, dihydropyran, tetrahydropyran, oxepane, oxocane, or from the group of the saccharides, for example alpha-glucose, beta-glucose, and
R¹, R², R³, R⁴, R⁵ are each as defined above, and
m, n, o, p are each as defined above, and
X¹ is as defined above, and
a is a natural integer and is zero, 1, 2, 3, 4, 5, 6, 7, 8, 9, 10, 11, 12, 13, 14, 15, 16, 17, 18, 19 and 20, and
b is a natural integer and is 2, 3, 4, 5, 6, 7, 8, 9 and 10, and
c is a natural integer and is zero, 1, 2, 3, 4, 5, 6, 7, 8, 9, 10, 11, 12, 13, 14, 15, 16, 17, 18, 19 and 20.

Illustrative examples, which do not, however, restrict the invention, of compounds of the formula V are:

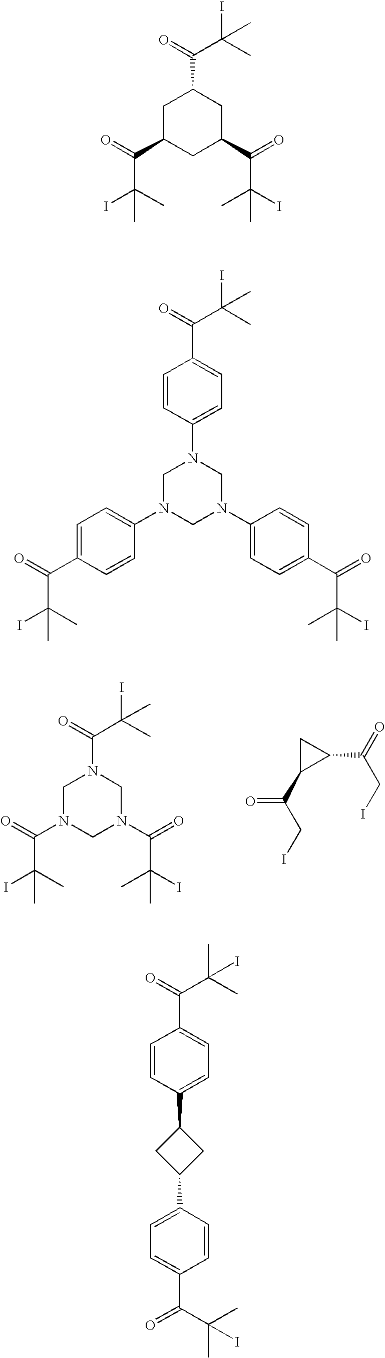

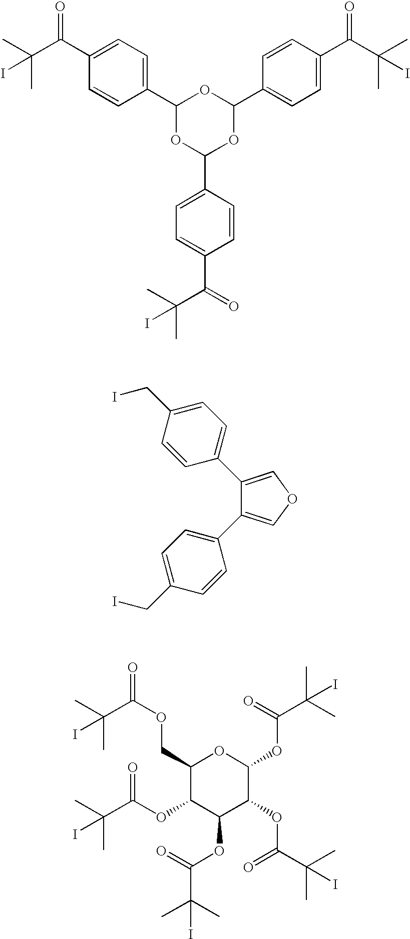

The inventive initiator systems are obtained by reacting a compound of the formula I, IV or V with a metal compound of the formula II. Preference is given to a reaction in which a metal compound of the formula II is used stoichiometrically in relation to the free radical-initiating halide groups X¹ present. An additive of the formula III may optionally be present when the catalyst system is prepared, or an additive of the formula III may optionally be introduced subsequently. The concentration of additive of the formula III may be between 0.001 and 100 mol % based on monomer used; the concentration of additive of the formula III is more preferably beteen 0.01 and 20 mol % based on monomer used. The initiator system may be prepared in the presence of one or more solvents or in vinyl esters, preferably in vinyl acetate, or in another liquid monomer.

The present invention provides a process for preparing and purifying polyvinyl esters, comprising the steps of:
(A) reacting at least one compound of the formula I with at least one metal compound of the formula II, optionally in the presence of at least one additive of the formula III:

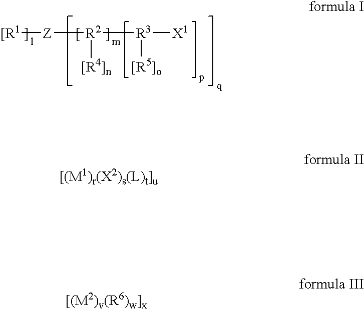

where:
Z is a central atom and is an atom of group 13 to 16 of the Periodic Table of the Elements, preferably carbon, silicon, nitrogen, phosphorus, oxygen or sulfur, more preferably carbon or silicon, and
X¹ is in each case the same or different and is a halogen atom, preferably fluorine, chlorine, bromine or iodine, more preferably chlorine, bromine or iodine, and
R¹ is the same or different and is hydrogen or a C₁-C₂₀ group, and
R² is the same or different and is a bridging C₁-C₂₀ group between the central atom Z and the initiating [R³—X¹] unit or silicon or oxygen, and
R³ is the same or different and is carbon or silicon, and
R⁴ is the same or different and is a hydrogen atom or a C₁-C₂₀ group, and
R⁵ is the same or different and is hydrogen or a C₁-C₂₀ group,
l is a natural integer and is zero, 1, 2 or 3, and
m is in each case the same or different and is a natural integer and is zero, 1, 2, 3, 4 and 5, and
n is in each case the same or different and is a natural integer and is zero, 1, 2, 3, 4, 5, 6, 7, 8, 9, 10, 11, 12, 13, 14, 15, 16, 17, 18, 19 and 20, and
o is in each case the same or different and is 1 or 2, and
p is in each case the same or different and is a natural integer and is 1, 2, 3, 4 and 5, and
q is a natural integer and is 2, 3 or 4, and
M¹ is in each case the same or different and is a transition metal of group 3 to 12 of the Periodic Table of the Elements, preferably chromium, molybdenum, ruthenium, iron, rhodium, nickel, palladium or copper, more preferably iron or ruthenium, and
X² is in each case the same or different and is oxygen or a halogen atom, more preferably fluorine, chlorine, bromine or iodine, and
L is in each case the same or different and is a ligand, preferably a carbon ligand, for example methyl, phenyl, cymene, cumene, tolyl, mesityl, xylyl, indenyl benzylidene, cyclopentadienyl or carbonyl, a nitrogen ligand, for example triethylamine, tetramethylethylenediamine, pyridine, 2,2′-bipyridyl, substituted 2,2′-bipyridyl, 1,10-phenanthroline, phenylpyridin-2-ylmethylenamine, acetonitrile, substituted imidazolidine or terpyridyl, a phosphorus ligand, for example triphenylphosphine, tricyclohexylphosphine, bis-(diphenylphosphino)ethane, bis(diphenylphosphino)-propane or BINAP, and
r is in each case the same or different and is a natural integer and is 1, 2, 3, 4 and 5, and
s is in each case the same or different and is a natural integer and is zero, 1, 2, 3, 4 and 5, and
t is in each case the same or different and is a natural integer and is zero, 1, 2, 3, 4 and 5, and
u is a natural integer and is 1, 2, 3, 4 and 5, and
M² is the same or different and is an element of group 1 to 15 of the Periodic Table of the Elements, more preferably Li, Mg, Ti, B, Al, P or N, and
R⁶ is the same or different and is hydrogen, a halogen atom or a C₁-C₂₀ group, more preferably methoxy, ethoxy, n-propoxy or i-propoxy, and
v is the same or different and is a natural integer and is 1, 2, 3, 4, 5, 6, 7 and 8, and
w is the same or different and is a natural integer and is 1, 2, 3, 4, 5, 6, 7 and 8, and
x is a natural integer and is 1, 2, 3, 4, 5, 6, 7 and 8,
(B) concentrating the reaction mixture from step A) to remove residual monomer and solvents, and
(C) dissolving the reaction mixture from step B) in one or more organic solvent(s),
(D) optionally oxidizing the catalyst in the mixture by stirring in the presence of atmospheric oxygen or adding oxidizing agents,
(E) optionally removing the reaction products obtained in the oxidation in step D),
(F) precipitating the polymers by adding the polymer solution to one or more nonpolar aprotic solvent(s) and removing the supernatant solvent and optionally drying the resulting polymer,
(G) optionally redissolving the polymer obtained from step F) in one or more organic solvent(s),
(H) precipitating the polymer by adding the solution from step G) to water or to an aqueous solution of an acid or an aqueous solution of a base, optionally with stirring and cooling,
(I) isolating the precipitated polymer, preferably by filtration or decanting off, optionally washing the polymer with water or one of the liquids mentioned under step H),
(J) optionally repeating steps G), H) and I),
(K) drying the polymer.

The solvents used in step C) are preferably (i) aromatic hydrocarbons, in particular toluene, benzene or xylene, (ii) ketones, in particular acetone, diethyl ketone or methyl isobutyl ketone, (iii) ethers, in particular diethyl ether, dibutyl ether, methyl tert-butyl ether, tetrahydrofuran, anisole or dioxane, (iv) esters, in particular such as methyl acetate or ethyl acetate, (v) alcohols, in particular methanol, ethanol or isopropanol, (vi) halogenated hydrocarbons, in particular dichloromethane or trichloromethane, and (vii) ethylene carbonate or (viii) N,N-dimethylformamide.

The oxidizing agents used in step D) are in particular hydrogen peroxide, sodium peroxide, sodium hypochlorite, sodium perborate, sodium peroxodisulfate, potassium peroxodisulfate, potassium permanganate, potassium chlorate, calcium peroxide, tert-butyl hydroperoxide, or m-chloroperbenzoic acid, and the oxidizing agents may be added either in substance or in solution.

The solvents used in step F) are in particular aliphatic hydrocarbons, more preferably n-pentane, n-hexane, isohexane or n-heptane.

The solvents used in step G) are preferably (i) aromatic hydrocarbons, in particular toluene, benzene or xylene, (ii) ketones, in particular acetone, diethyl ketone or methyl isobutyl ketone, (iii) ethers, in particular diethyl ether, dibutyl ether, methyl tert-butyl ether, tetrahydrofuran, anisole or dioxane, (iv) esters, in particular such as methyl acetate or ethyl acetate, (v) alcohols, in particular methanol, ethanol or isopropanol, (vi) halogenated hydrocarbons, in particular dichloromethane or trichloromethane, and (vii) ethylene carbonate or (viii) N,N-dimethylformamide.

The acids used in step H) are preferably inorganic and/or organic acids, in particular hydrogen fluoride, hydrochloric acid, hydrogen bromide, hydrogen iodide, phosphoric acid, phosphorous acid, hypophosphorous acid, sulfuric acid, sulfurous acid, acetic acid, tartaric acid, nitric acid, nitrous acid, ammonium chloride or citric acid. The bases used in step H) are preferably inorganic and/or organic bases, in particular sodium hydroxide, potassium hydroxide, magnesium hydroxide, calcium hydroxide, ammonia, tetramethylethylene-diamine, trimethylamine, triethylamine, EDTA sodium salt or hexamethylenetetramine.

The polymer purified by the process according to the invention is colorless and does not contain any solvent or any residual monomer.

A preferred embodiment of the process according to the invention comprises steps A) and B) as described above, dissolution of the reaction mixture as per step C) in acetone, toluene and/or methanol, precipitation of the polymer as per step F) by adding the solution from step C) to n-heptane and subsequent removal of the solvent, redissolution of the polymer in acetone as per step G), addition of the solution, preferably with stirring, to an inorganic acid as per step H), isolation of the precipitated polymer and washing of the polymer with water and subsequent drying of the polymer.

A particularly preferred embodiment of the process according to the invention comprises steps A) and B) as described above, dissolution of the reaction mixture as per step C) in acetone, precipitation of the polymer as per step F) by adding the solution from step C) to n-heptane and subsequent removal of the solvent, redissolution of the polymer in acetone as per step G), addition of the solution, preferably with stirring, to one molar hydrochloric acid as per step H), isolation of the precipitated polymer and washing of the polymer with water and subsequent drying of the polymer.

The present invention further provides a process for preparing and purifying polyvinyl esters, comprising the steps of:
(A) reacting at least one compound of the formula I with at least one metal compound of the formula II, optionally in the presence of at least one additive of the formula III as described above,
(B) concentrating the reaction mixture from step A) to remove residual monomer and solvents as described above,
(C) dissolving the reaction mixture from step B) in one or more organic solvent(s) as described above,
(D) optionally oxidizing the catalyst in the mixture by stirring in the presence of atmospheric oxygen or adding oxidizing agents as described above,
(E) optionally removing the reaction products obtained in the oxidation in step D) as described above,
(F) optionally precipitating the polymers by adding the polymer solution to one or more nonpolar aprotic solvent(s) and removing the supernatant solvent and optionally drying the resulting polymer as described above,
(G) optionally redissolving the polymer obtained from step F) in one or more organic solvent(s) as described above,
(L) adding the solution from C) to water or an aqueous solution of an acid or to an aqueous solution of a base, optionally with stirring,
(M) stirring the mixture from L) to extract the impurities, separating the phases and removing the aqueous phase,
(N) optionally adding one or more organic solvents to dissolve the polymer from M),
(O) optionally repeating steps L), M) and/or N),
(P) isolating and drying the polymer by removing the solvent, optionally under reduced pressure.

The solvents and reagents used under steps A), C), D), E) and F) have already been described above under steps A), C), D), E) and F).

The acids used in step L) are preferably inorganic and/or organic acids, in particular hydrogen fluoride, hydrochloric acid, hydrogen bromide, hydrogen iodide, phosphoric acid, phosphorous acid, hypophosphorous acid, sulfuric acid, sulfurous acid, acetic acid, tartaric acid, nitric acid, nitrous acid, ammonium chloride or citric acid. The bases used in step L) are preferably inorganic and/or organic bases, in particular sodium hydroxide, potassium hydroxide, magnesium hydroxide, calcium hydroxide, ammonia, tetramethylethylenediamine, trimethylamine, triethylamine, EDTA sodium salt or hexamethylenetetramine.

The solvents used in step N) are preferably (i) aromatic hydrocarbons, in particular toluene, benzene or xylene, (ii) ketones, in particular acetone, diethyl ketone or methyl isobutyl ketone, (iii) ethers, in particular diethyl ether, dibutyl ether, methyl tert-butyl ether, tetrahydrofuran, anisole or dioxane, (iv) esters, in particular such as methyl acetate or ethyl acetate, (v) alcohols, in particular methanol, ethanol or isopropanol, (vi) halogenated hydrocarbons, in particular dichloromethane or trichloromethane, and (vii) ethylene carbonate or (viii) N,N-dimethylformamide.

A preferred embodiment of the further process according to the invention comprises steps A) and B) as described above, dissolution of the polymer as per step C) in acetone and/or methanol, precipitation of the polymer as per step F) by adding the solution from step C) to n-heptane and subsequent removal of the solvent, redissolution of the polymer in toluene, acetone and dichloromethane as per step G), addition of the solution, preferably with stirring, to an inorganic acid as per step L), stirring of the mixture to extract the impurities, separation of the phases and removal of the organic phase as per step M), addition of acetone to the organic phase as per step N), repetition of steps L), M) and N) as per step O), isolation and drying of the polymer by removing the solvents under reduced pressure as per step P).

A particularly preferred embodiment of the further process according to the invention comprises steps A) and B) as described above, dissolution of the polymer as per step C) in toluene, acetone and dichloromethane, addition of the solution, preferably with stirring, to 1 molar hydrochloric acid as per step L), stirring of the mixture to extract the impurities, separation of the phases and removal of the organic phase as per step M), addition of acetone to the organic phase as per step N), repetition of steps L), M) and N) as per step 0), isolation and drying of the polymer by removing the solvents under reduced pressure as per step P).

In one variant of the process, instead of the compound of the formula (I), a compound of the formula (IV) may be used 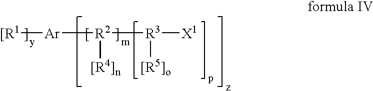
where
Ar is an aromatic basic structure having at least four carbon atoms, in which one or more carbon atoms may be exchanged for boron, nitrogen or phosphorus, preferred aromatic or heteroaromatic basic structures being derived from benzene, biphenyl, naphthalene, anthracene, phenanthrene, triphenylene, quinoline, pyridine, bipyridine, pyridazine, pyrimidine, pyrazine, triazine, benzopyrrole, benzotriazole, benzopyridine, benzopyrazidine, benzopyrimidine, benzopyrazine, benzotriazine, indolizine, quinolizine, carbazole, acridine, phenazine, benzoquinoline, phenoxazine, each of which may also optionally be substituted, and
R¹, R², R³, R⁴, R⁵ are each as defined under formula (I), and
m, n, o, p are each as defined under formula (I), and
X¹ is as defined under formula (I), and
y is a natural integer and is zero, 1, 2, 3, 4, 5, 6, 7, 8, 9, 10, 11, 12, 13, 14, 15, 16, 17, 18, 19 and 20, and
z is a natural integer and is 2, 3, 4, 5, 6, 7, 8, 9 and 10.

In a further variant of the process, instead of the compound of the formula (I), a compound of the formula (V) may be used 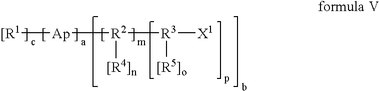
where
Ap is a cyclic nonaromatic basic structure having at least three carbon atoms which may also contain heteroatoms such as nitrogen, boron, phosphorus, oxygen or sulfur, preferred aliphatic basic structures being derivable from the group of cycloalkyl, for example cyclopropyl, cyclobutyl, cyclopentyl, cyclohexyl, cycloheptyl, cyclooctyl, cyclononyl, or from the cycloheteralkyl group, for example aziridine, azetidine, pyrrolidine, piperidine, azepane, azocane, 1,3,5-triazinane, 1,3,5-trioxane, oxetane, furan, dihydrofuran, Tetrahydrofuran, pyran, dihydropyran, tetrahydropyran, oxepane, oxocane, or from the group of the saccharides, for example alpha-glucose, beta-glucose, and
R¹, R², R³, R⁴, R⁵ are each as defined under formula (I), and
m, n, o, p are each as defined under formula (I), and
X¹ is as defined under formula (I), and
a is a natural integer and is zero, 1, 2, 3, 4, 5, 6, 7, 8, 9, 10, 11, 12, 13, 14, 15, 16, 17, 18, 19 and 20, and
b is a natural integer and is 2, 3, 4, 5, 6, 7, 8, 9 and 10, and
c is a natural integer and is zero, 1, 2, 3, 4, 5, 6, 7, 8, 9, 10, 11, 12, 13, 14, 15, 16, 17, 18, 19 and 20.

The present invention further provides a process for polymerizing vinyl esters using an inventive catalyst system, polymerizing meaning either the homopolymerization of vinyl esters or the copolymerization of vinyl esters with other olefins.

Examples of other olefins are 1-olefins having 2-20, preferably from 2 to 10, carbon atoms, such as ethene, propene, 1-butene, 1-pentene, 1-hexene, 1-decene, 4-methyl-1-pentene or 1-octene, styrene, dienes such as 1,3-butadiene, 1,4-hexadiene, vinylnorbornene, norbornadiene, ethylnorbornadiene and cyclic olefins such as norbornene, cyclopentadiene, tetracyclododecene or methylnorbornene, and polar monomers such as methyl acrylate, methyl methacrylate, acrylic acid, ethyl acrylate, n-butyl acrylate and 2-ethylhexyl acrylate.

In the process according to the invention, preference is given to homopolymerizing vinyl acetate, or to copolymerizing vinyl acetate with one or more 1-olefins having from 4 to 20 carbon atoms, such as styrene, norbornene, methyl acrylate, methyl methacrylate, acrylic acid, ethyl acrylate, n-butyl acrylate or 2-ethylhexyl acrylate. Examples of such copolymers are vinyl acetate/methyl methacrylate copolymers or vinyl acetate/methyl methacrylate/styrene terpolymers.

The polymerization is carried out at a temperature of from 0 to 300° C., preferably from 50 to 200° C., even more preferably 50-80° C. The pressure is from 0.5 to 2000 bar, preferably from 1 to 64 bar. The polymerization may be carried out in solution, in bulk, in suspension or in emulsion, continuously or batchwise, and in one or more stages. Suitable solvents for the polymerization are, for example, ethers such as diethyl ether, dibutyl ether, methyl tert-butyl ether, tetrahydrofuran, dioxane, anisole, diphenyl ether, ethyl phenyl ether, aliphatic hydrocarbons such as pentane, hexane and the like, or aromatic hydrocarbons such as benzene, toluene, xylenes and the like, and also ethyl acetate, acetone, N,N-dimethylformamide, ethylene carbonate, methanol, ethanol, propanol, i-propanol or water. It is also possible in accordance with the invention to use mixtures of different solvents in varying ratios.

Very particular preference is given to initiator systems for preparing polyvinyl acetate which consist of a compound of the formula I, IV or V, cyclopentadienyliron dicarbonyl dimer (formula II) and aluminum triisopropoxide (formula III).

The present invention further provides the polymers which have specific geometries and are based on polyvinyl esters of the formulae VI, VII and VIII, and are obtained from the reaction of a central unit of the formula I, IV or V with vinyl esters, or vinyl esters with one or more 1-olefins: 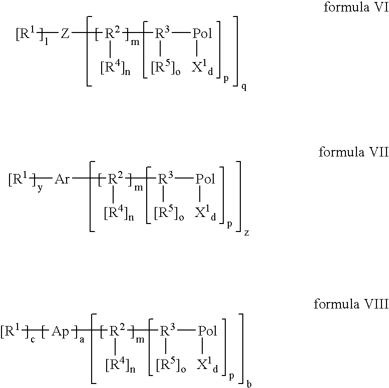
where
Z, Ar, Ap are each as defined above, and
R¹, R², R³, R⁴, R⁵ are each as defined above, and
l, m, n, o, p, q, y, z, a, b, c are each as defined above, and
X¹ is as defined above, and
d may be the same or different and is zero or one, and
Pol is a polymer based on a polyvinyl ester, more preferably a homo- or copolymer based on polyvinyl acetate.

The chain length of the polymer Pol may be determined by the reaction parameters (time, temperature, pressure, concentrations). The chain length is more preferably from 3 to 10 000. Thus, in example 3: 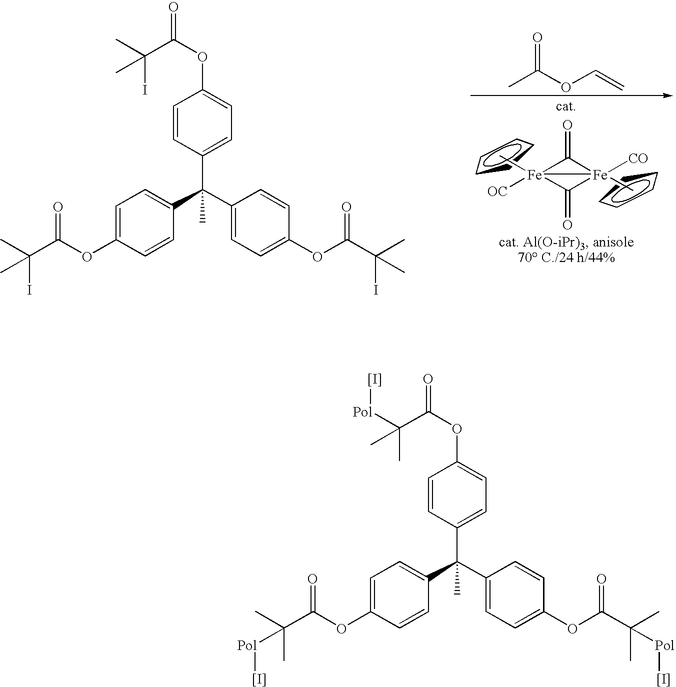
under the conditions specified (solvent: anisole, 4.8 mmol of vinyl acetate, 5 mol % of iron catalyst based on vinyl acetate, 5 mol % of aluminum triisopropoxide, pressure=1 bar, T=70° C.), a polyvinyl acetate having a specific geometry with a chain length of 12 vinyl acetate units per arm is obtained after 12 hours, a polyvinyl acetate having a specific geometry with a chain length of 25 vinyl acetate units per arm after 24 hours. The polymer exhibits the following properties: T_{g}=41° C. (ΔCₚ=0.42 J/(g*K)); M_{w}=7200 g/mol; Mₙ=2200 g/mol. M_{w}/Mₙ=3.2. The glass transition temperature is distinctly higher compared to commercially available polyvinyl acetate (T_{g}=28° C.).

Illustrative examples, which do not, however, restrict the invention, of inventive polymers are: 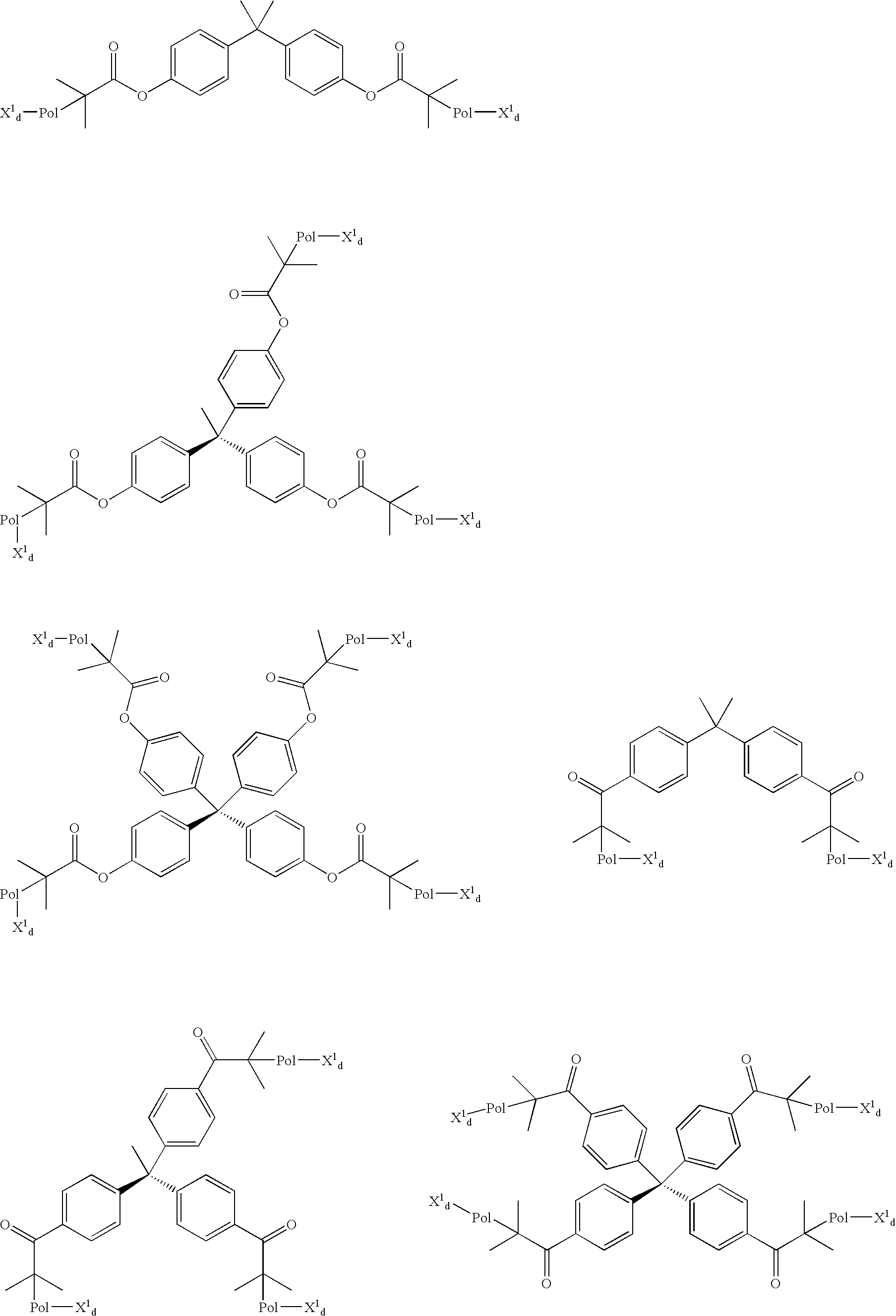 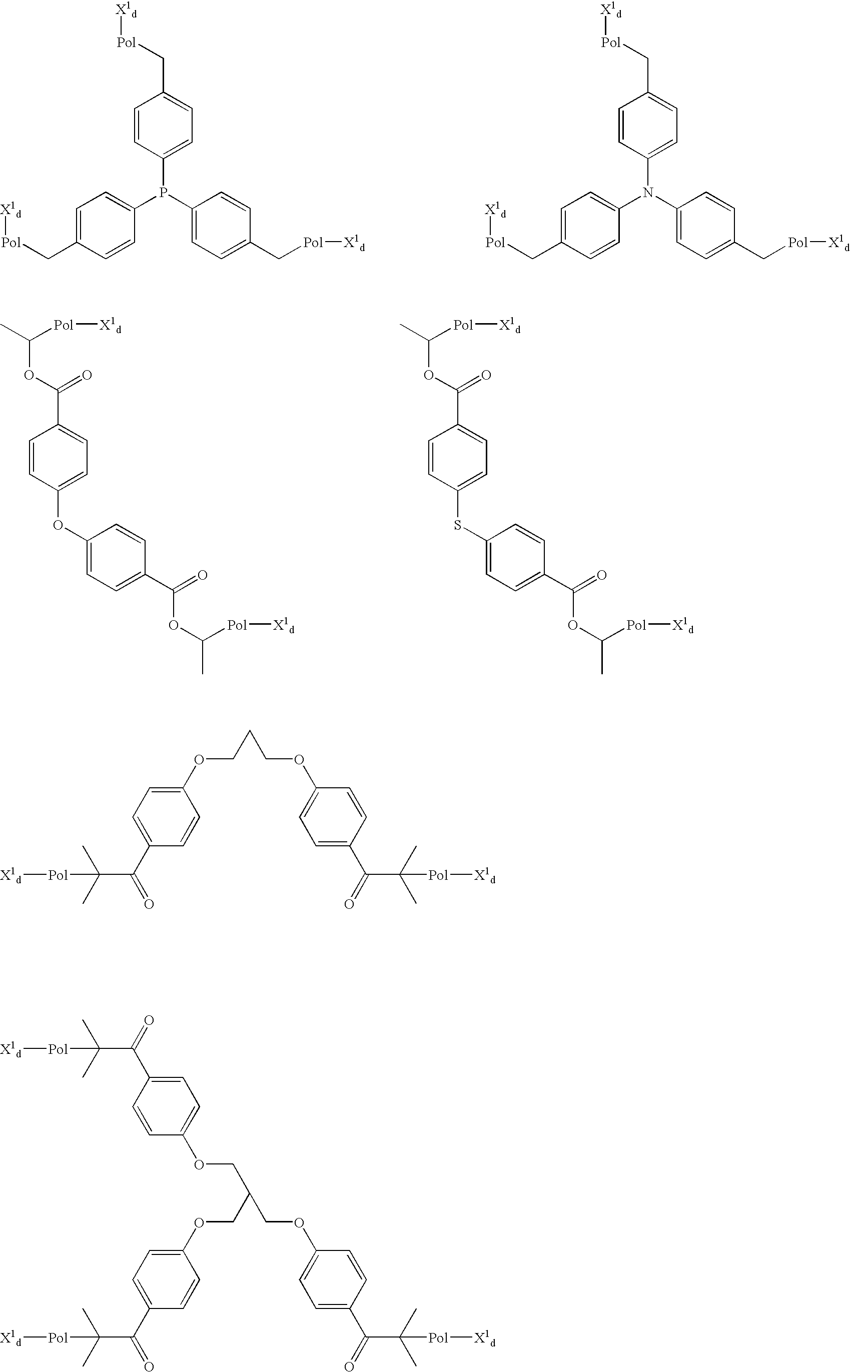 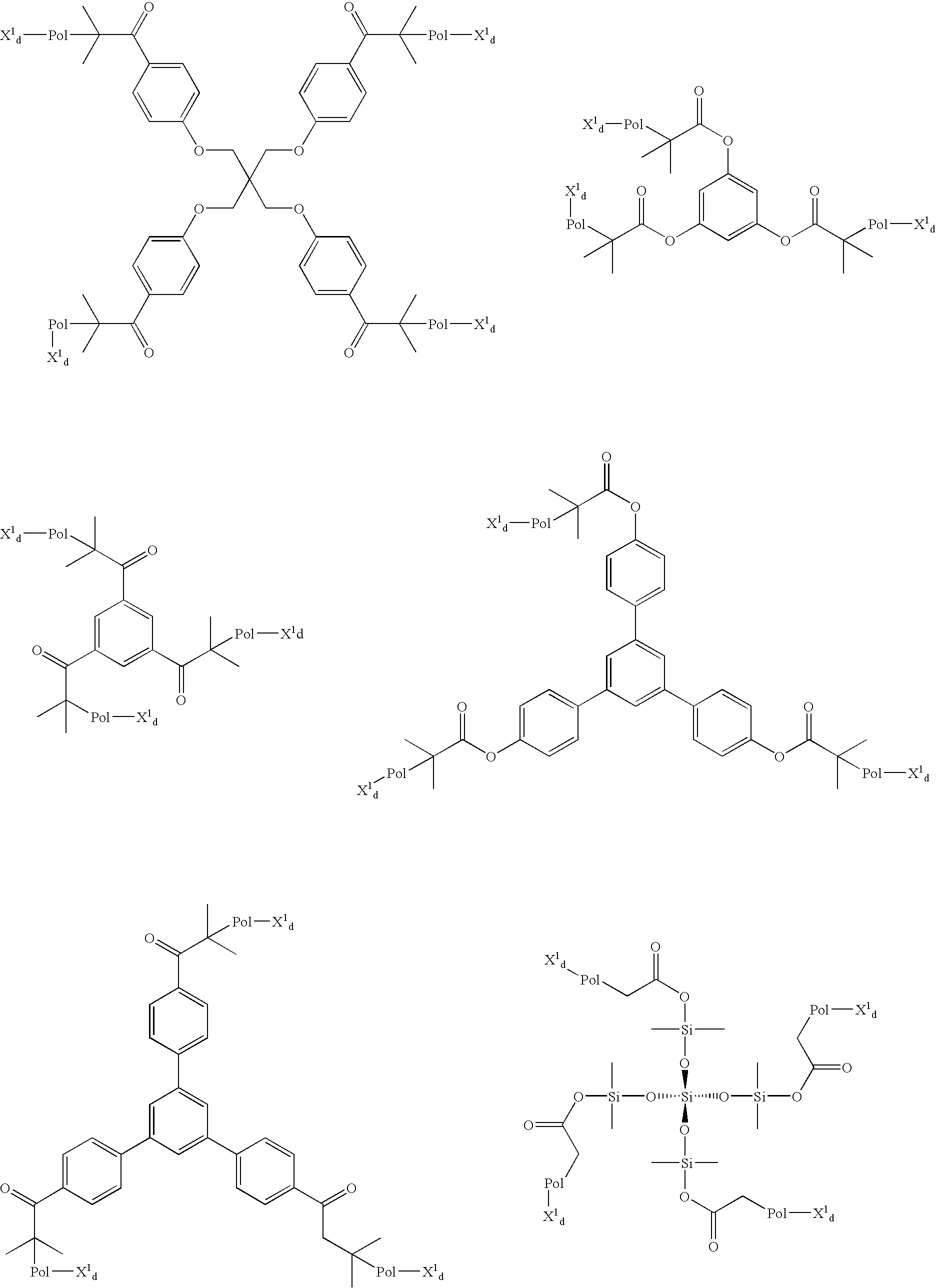 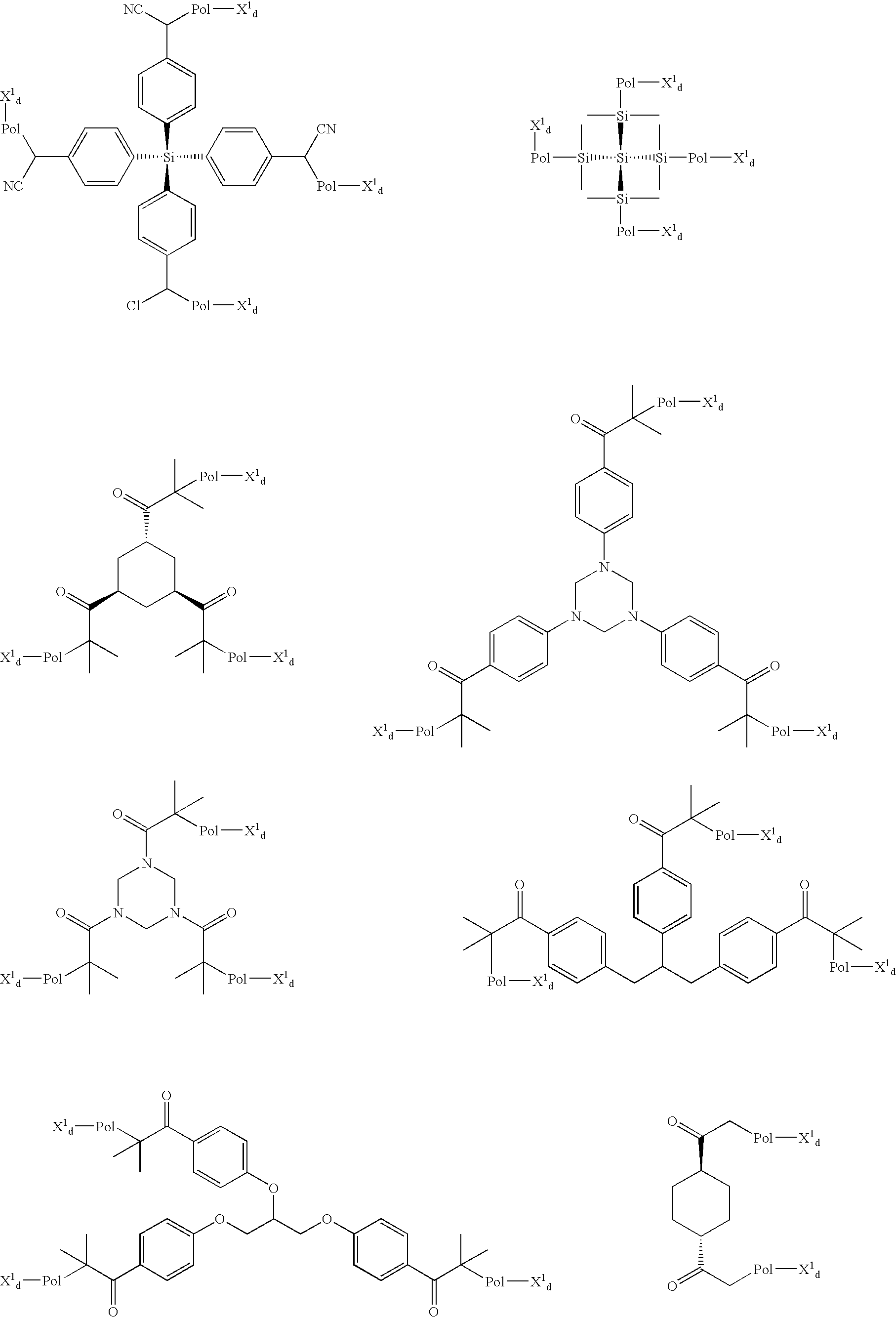 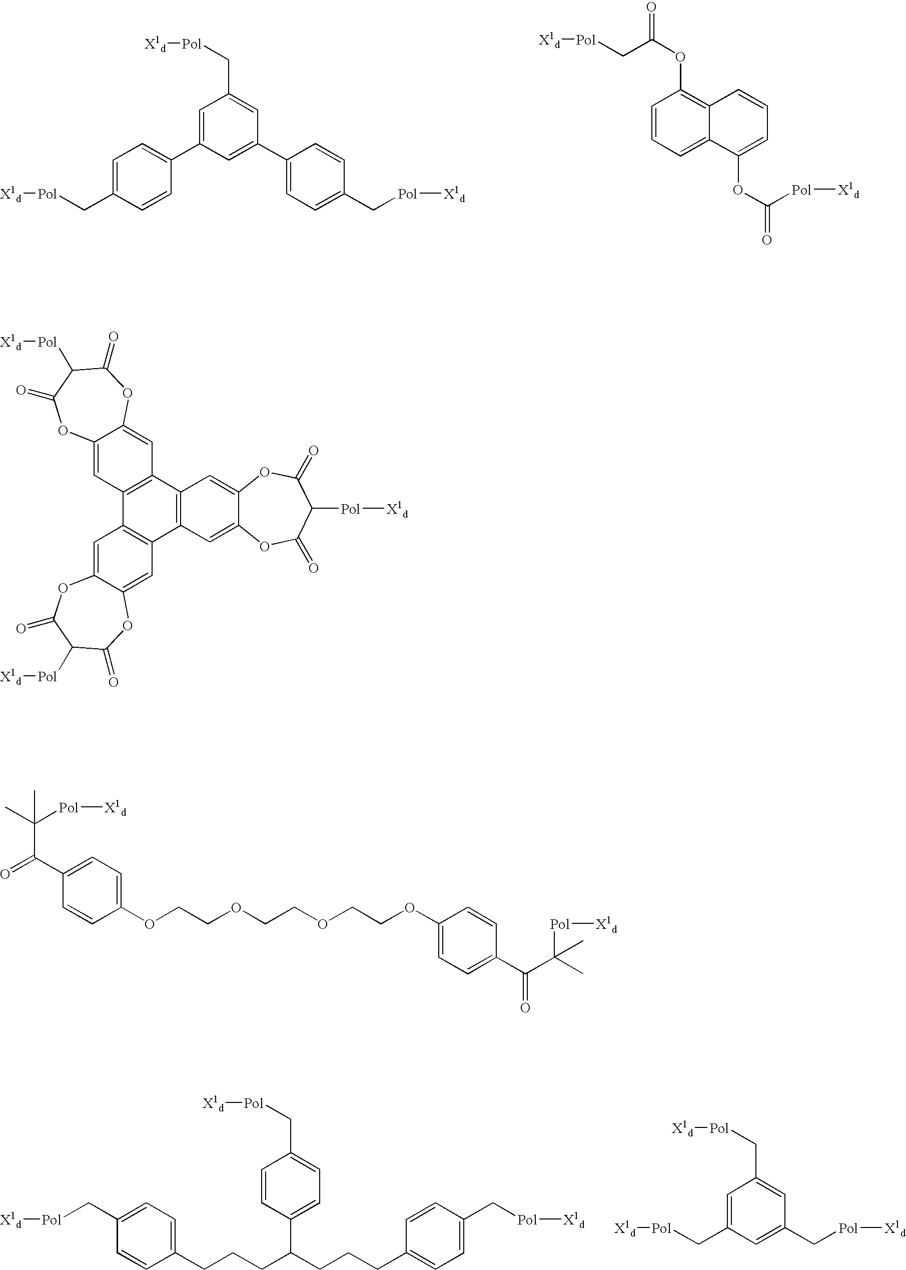 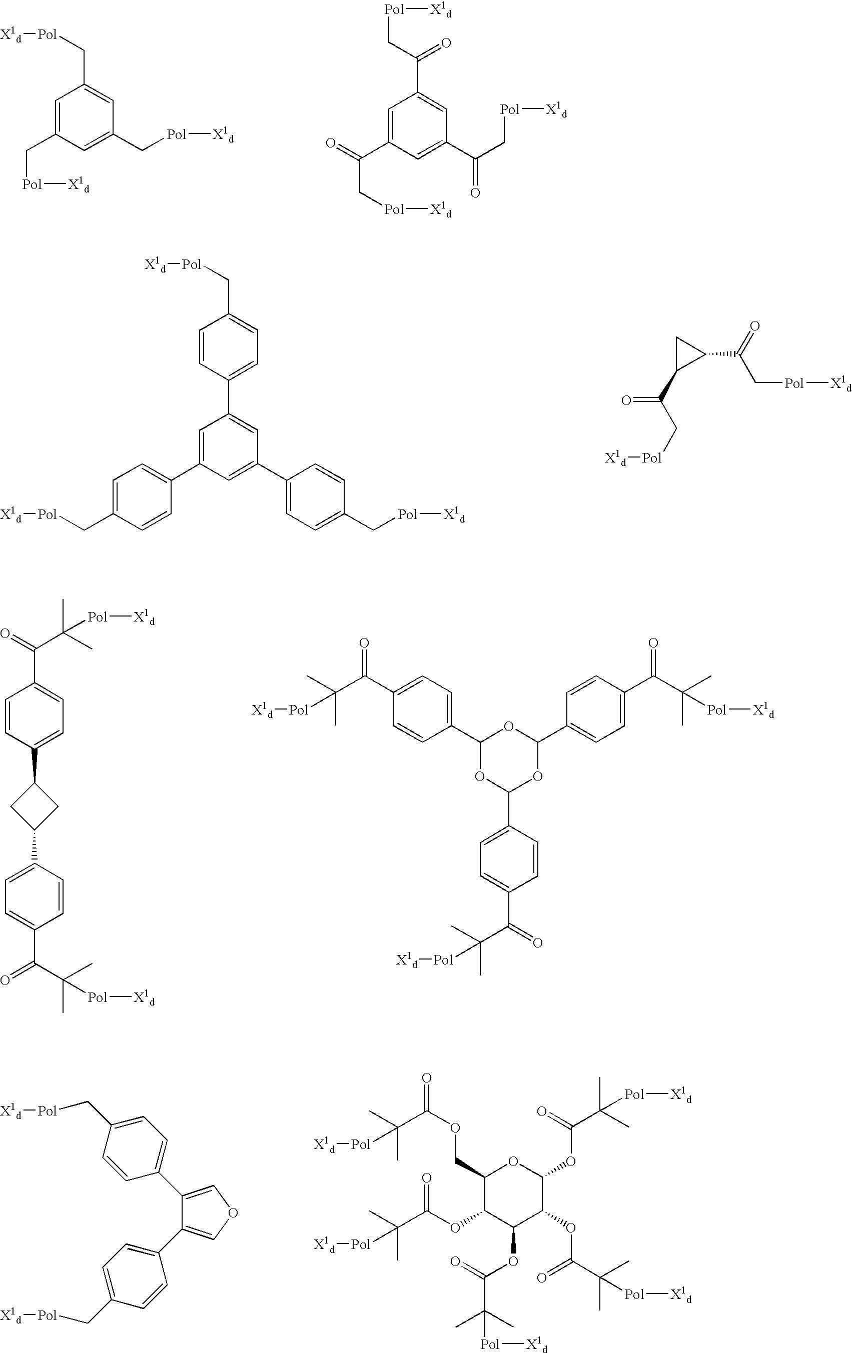
where Pol, X¹ and d are each as defined above.

The polymers which are based on polyvinyl esters and have specific geometries may be chemically modified. For example, the polymers may be hydrolyzed to obtain polyvinyl alcohols having specific geometries. These may be reacted, for example, with butyraldehyde to give polyvinyl butyrals having specific geometries.

The polymers of the formula VI, VII and VIII are particularly suitable as additives for fuels and motor oils, as additives for concrete, as additives in papermaking, as an adhesive (component), as lubricants, as lacquer components, as high-performance plastics and as starting materials for novel materials based on polyvinyl alcohol and polyvinyl butyral having specific geometries.

The invention is illustrated by the examples which follow which do not, however, restrict the invention.

General comments: The organometallic compounds were prepared and handled with exclusion of air and moisture under argon protective gas (Schlenk technology or glovebox). All solvents required were purged with argon and rendered absolute over molecular sieve.

### EXAMPLE 1

### 4-{1,1-bis[4-(2-Bromo-2-methylpropionyl-oxy) phenyl]ethyl}phenyl 2-bromo-2-methylpropionate

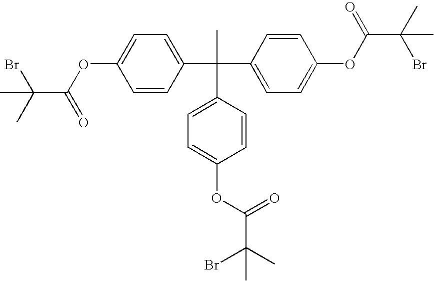

In a 1 l two-neck round-bottom flask, 25 g (82 mmol) of tris(p-hydroxyphenyl)-ethane are suspended in 500 ml of dichloromethane. 26 g (36 ml, 261 mmol) of triethylamine and 1 mol % of 4-N,N-dimethylaminopyridine (100 mg, 0.82 mmol) are added. Afterward, 60 g (261 mmol) of 2-bromisobutyric acid in 250 ml of dichloromethane are added dropwise at 0° C. within 15 min. On completion of addition, the mixture is refluxed for 2.5 h and stirred at room temperature overnight. The reaction mixture is washed three times with 350 ml each time of water and dried over magnesium sulfate. The solvent is removed under reduced pressure to obtain the product as a white powder. Yield: 61 g (100%). ¹H NMR (500 MHz, CDCl₃): δ=7.10, 7.03 (2×m, 12H, aromatic H), 2.16 (s, 3H, CH₃), 2.05 (s, 18H, CH₃) ppm.

### EXAMPLE 2

### 4-{1,1-bis[4-(2-Iodo-2-methylpropionyl-oxy)phenyl]ethyl}phenyl 2-iodo-2-methylpropionate

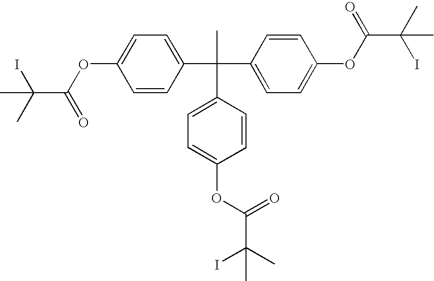

In a 2 l round-bottom flask, 20 g (26.5 mmol) of the trisbromide from example 1 are dissolved in 500 ml of degassed acetone. After the addition of 59.7 g (398 mmol, 15 eq.) of sodium iodide, the mixture is refluxed for 24 h. 700 ml of water are added to the brown suspension and the mixture is stirred at RT for 30 min. The mixture is extracted 4 times with 400 ml each time of diethyl ether and the organic phase is washed twice with 500 ml each time of water. After drying over magnesium sulfate, the solvent is removed under reduced pressure to obtain a brown, semicrystalline solid (22.4 g). The solid is taken up in 100 ml of methanol, heated briefly and stirred for 0.5 h. The product is obtained as a light beige solid by filtration and washing until the filtrate is colorless (approx. 50 ml of methanol). Yield: 14.1 g (15.8 mmol/60%). For further purification, the product may be recrystallized from a CHCl₃/heptane mixture. ¹H NMR (500 MHz, CDCl₃): =7.11, 7.04 (2×m, 12H, aromatic H), 2.19 (s, 18H, CH₃), 2.16 (s, 3H, CH₃) ppm.

### EXAMPLE 3

### Polymerization of Vinyl Acetate With the Example 2 Initiator

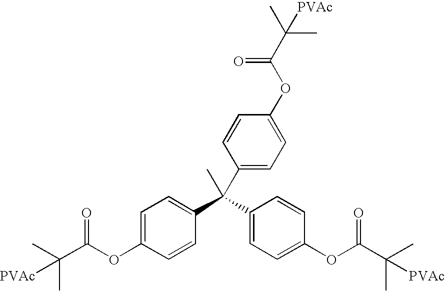

A 50 ml Schlenk tube with stirrer bar is initially charged with 85 mg (0.24 mmol) of cyclopentadienyliron dicarbonyl dimer. The following reagents are added to the iron complex in the following sequence:
1) 0.19 ml of anisole
2) 4.42 ml (4.13 g, 4.8 mmol) of vinyl acetate
3) 4.00 ml of a 0.0391 M solution of the trisiodide from example 2 (corresponds to 0.16 mmol)
4) 0.96 ml of a 0.25 M solution of aluminum triisopropoxide in anisole (corresponds to 0.24 mmol).

Subsequently, the reaction mixture is stirred in a closed Schlenk tube at 70° C. for 24 h. After cooling to room temperature, the solvent is removed completely under reduced pressure. 20 ml of toluene are added to the residue. The organic phase is washed three times with 10 ml each time of 2M HCl; the combined aqueous phases are extracted twice with 20 ml each time of toluene. The combined organic phases are dried over magnesium sulfate and the solvent is removed completely under reduced pressure (yield: 2.5 g, 60%). For further purification, the following steps may be carried out:

The residue is taken up in a little acetone and purified by column chromatography on silica gel (eluent: acetone). The eluate is concentrated to 3 ml and added to 30 ml of pentane. The pentane is decanted off and discarded, and the product is subsequently dissolved once again in 3 ml of acetone and added to 30 ml of pentane. After the pentane has been decanted off, the light yellow residue is dried in an oil-pump vacuum to obtain the product as a solid foam. Yield: 1.8 g (44%). ¹H NMR (500 MHz, CDCl₃): δ=7.19-6.85 (m, aromatic H), 4.83 (s, br, PVAc), 2.13, 1.98, 1.82, 1.72 (4×s, br, PVAc) ppm. ¹³C NMR (125 MHz, CDCl₃): δ=170.4, 170.3, 149.2, 131.4, 129.46, 128.46, 120.8, 120.6, 113.8, 67.7, 66.9, 66,7, 66.6, 66.5, 66.3, 66.0, 55.1, 51.5, 39.8, 39.5, 38.7, 38.6, 21.1, 20.9, 20.8 ppm. T_{g}=41° C. (ΔCₚ=0.42 J/(g*K)). M_{w}=7200 g/mol. Mₙ=2200 g/mol. M_{w}/Mₙ=3.2.

### EXAMPLE 4

### Preparation of a Polyvinyl Acetate Star Polymer According to DE 10238659

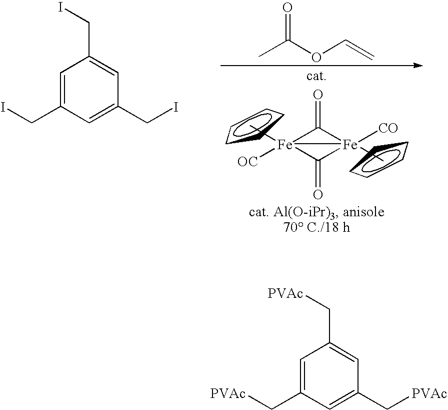

5.25 g (15 mmol) of cyclopentadienyldicarbonyliron (I) dimer are introduced into a baked-out 1 l three-neck flask with reflux condenser, precision glass stirrer and pressure equalizer (argon line). Afterward, the apparatus is evacuated three times and aerated with argon. Addition of 12 ml of anisole (anhydrous & degassed) dissolves the iron catalyst. Afterward, 552 ml of vinyl acetate (distilled), 5 g (10 mmol) of 1,3,5-trisiodomethylbenzene in 82 ml of anisole (anhydrous & degassed) and 60 ml of aluminum triisopropoxide in anisole (15 mmol of Al(O-iPr)₃ in anisole, c=0.25 mol/l) are added. Afterward, the reaction mixture is stirred with a precision glass stirrer (150 rpm) heated to 70° C. for 18 hours.

### EXAMPLE 5

### Purification of the Polyvinyl Acetate Star Polymer Prepared Under Example 4

The solvent and residual vinyl acetate are removed at 70° C. under reduced pressure. The reaction mixture is dissolved in 800 ml of acetone and added to 1.25 l of n-heptane. The mixture is left to stand for one hour and the supernatant n-heptane is decanted off. The thus obtained dark brown polymer is dried under reduced pressure for two hours and taken up again in 800 ml of acetone. The dark polymer solution is added dropwise with vigorous stirring with a KPG stirrer to 2 l of an ice/2 M hydrochloric acid mixture (1 kg of ice/l 1 of 2M HCl). The thus obtained polymer powder is filtered off, washed twice to neutrality with 250 ml each time of water, and freeze-dried under reduced pressure. The thus obtained polymer (yield: 270 g) is colorless and no longer contains any anisole.

### EXAMPLE 6

### Purification of the Polyvinyl Acetate Star Polymer Prepared Under Example 4, by Extraction

The solvent and residual vinyl acetate are removed at 70° C. under reduced pressure. 50 g of the reaction mixture are dissolved in 1000 ml of acetone, 500 ml of toluene and 20 ml of dichloromethane, and added to 1.25 l of 1M HCl. After stirring for one hour, the mixture is left to stand until the phases separate and the aqueous phase is removed. The volume of the aqueous phase is determined and the same amount of acetone as has dissolved in the aqueous phase is added to the organic phase (V_{acetone}=V_{measured}−V_{aqueous, used}). The organic phase is then added to 1.25 l of water and stirred again. The aqueous phase is removed again from the organic phase. Concentration of the organic phase on a rotary evaporator and subsequent drying allows the polymer to be isolated. The thus obtained polymer (yield: 48 g) is colorless and no longer contains any anisole.

1. A polymer based on polyvinyl esters of the formulae VI, VII and VIII 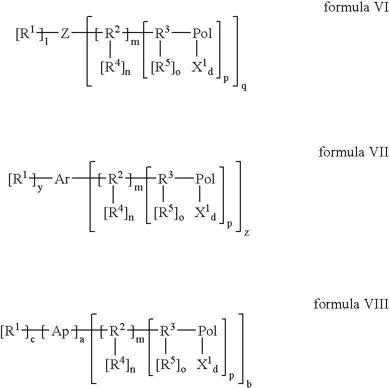
where
Pol is a polymer based on a polyvinyl ester, and is more preferably a homo- or copolymer based on polyvinyl acetate,
Z is a central atom and is an atom of group 13 to 16 of the Periodic Table of the Elements, preferably carbon, silicon, nitrogen, phosphorus, oxygen or sulfur, more preferably carbon or silicon, and
X¹ is in each case the same or different and is a halogen atom, preferably fluorine, chlorine, bromine or iodine, more preferably chlorine, bromine or iodine, and
R¹ is the same or different and is hydrogen or a C₁-C₂₀ group, and
R² is the same or different and is a bridging C₁-C₂₀ group between the central atom Z and the initiating [R³—X¹] unit or silicon or oxygen, and
R³ is the same or different and is carbon or silicon, and
R⁴ is the same or different and is a hydrogen atom or a C₁-C₂₀ group, and
R⁵ is the same or different and is hydrogen or a C₁-C₂₀ group,
l is a natural integer and is zero, 1, 2 or 3, and
m is in each case the same or different and is a natural integer and is zero, 1, 2, 3, 4 and 5, and
n is in each case the same or different and is a natural integer and is zero, 1, 2, 3, 4, 5, 6, 7, 8, 9, 10, 11, 12, 13, 14, 15, 16, 17, 18, 19 and 20, and
o is in each case the same or different and is 1 or 2, and
p is in each case the same or different and is a natural integer and is 1, 2, 3, 4 and 5, and
q is a natural integer and is 2, 3 and 4, and
Ar is an aromatic basic structure having at least four carbon atoms, in which one or more carbon atoms may be exchanged for boron, nitrogen or phosphorus, preferred aromatic or heteroaromatic basic structures being derived from benzene, biphenyl, naphthalene, anthracene, phenanthrene, triphenylene, quinoline, pyridine, bipyridine, pyridazine, pyrimidine, pyrazine, triazine, benzopyrrole, benzotriazole, benzopyridine, benzopyrazidine, benzopyrimidine, benzopyrazine, benzotriazine, indolizine, quinolizine, carbazole, acridine, phenazine, benzoquinoline, phenoxazine, each of which may also optionally be substituted, and
y is a natural integer and is zero, 1, 2, 3, 4, 5, 6, 7, 8, 9, 10, 11, 12, 13, 14, 15, 16, 17, 18, 19 and 20, and
z is a natural integer and is 2, 3, 4, 5, 6, 7, 8, 9 and 10,
Ap is a cyclic nonaromatic basic structure having at least three carbon atoms which may also contain heteroatoms such as nitrogen, boron, phosphorus, oxygen or sulfur, preferred aliphatic basic structures being derivable from the group of cycloalkyl, for example cyclopropyl, cyclobutyl, cyclopentyl, cyclohexyl, cycloheptyl, cyclooctyl, cyclononyl, or from the cycloheteralkyl group, for example aziridine, azetidine, pyrrolidine, piperidine, azepane, azocane, 1,3,5-triazinane, 1,3,5-trioxane, oxetane, furan, dihydrofuran, tetrahydrofuran, pyran, dihydropyran, tetrahydropyran, oxepane, oxocane, or from the group of the saccharides, for example alpha-glucose, beta-glucose, and
a is a natural integer and is zero, 1, 2, 3, 4, 5, 6, 7, 8, 9, 10, 11, 12, 13, 14, 15, 16, 17, 18, 19 and 20, and
b is a natural integer and is 2, 3, 4, 5, 6, 7, 8, 9 and 10, and
c is a natural integer and is zero, 1, 2, 3, 4, 5, 6, 7, 8, 9, 10, 11, 12, 13, 14, 15, 16, 17, 18, 19 and 20,
d may be the same or different and is zero or one.

2. The polymer as claimed in claim 1, characterized in that Pol is a copolymer based on a polyvinyl ester having one or more 1-olefins having from 4 to 20 carbon atoms.

3. The polymer as claimed in claim 1, characterized in that Pol is a homopolymer based on polyvinyl acetate.

4. The polymer as claimed in claim 1, characterized in that Pol is a copolymer based on polyvinyl acetate having one or more 1-olefins having from 4 to 20 carbon atoms.

5. The use of the polymers as claimed in any one of claims 1 to 4 as additives for fuels and motor oils, as additives for concrete, as additives in papermaking, as an adhesive (component), as a lubricant, as a lacquer component, as a high-performance plastic and as a starting material for the preparation of polymers based on polyvinyl alcohol and polyvinyl butyral.

6. An initiator system for preparing polyvinyl esters, comprising at least one compound of the formula I, at least one metal compound of the formula II and optionally at least one additive of the formula III: 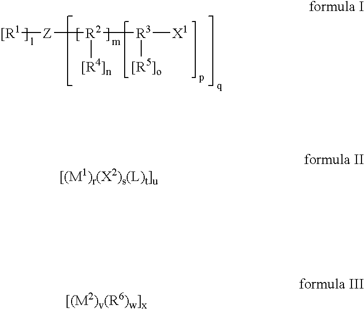
where:
Z is a central atom and is an atom of group 13 to 16 of the Periodic Table of the Elements, preferably carbon, silicon, nitrogen, phosphorus, oxygen or sulfur, more preferably carbon or silicon, and
X¹ is in each case the same or different and is a halogen atom, preferably fluorine, chlorine, bromine or iodine, more preferably chlorine, bromine or iodine, and
R¹ is the same or different and is hydrogen or a C₁-C₂₀ group, and
R² is the same or different and is a bridging C₁-C₂₀ group between the central atom Z and the initiating [R³—X¹] unit or silicon or oxygen, and
R³ is the same or different and is carbon or silicon, and
R⁴ is the same or different and is a hydrogen atom or a C₁-C₂₀ group, and
R⁵ is the same or different and is hydrogen or a C₁-C₂₀ group,
l is a natural integer and is zero, 1, 2 or 3, and
m is in each case the same or different and is a natural integer and is zero, 1, 2, 3, 4 and 5, and
n is in each case the same or different and is a natural integer and is zero, 1, 2, 3, 4, 5, 6, 7, 8, 9, 10, 11, 12, 13, 14, 15, 16, 17, 18, 19 and 20, and
o is in each case the same or different and is 1 or 2, and
p is in each case the same or different and is a natural integer and is 1, 2, 3, 4 and 5, and
q is a natural integer and is 2, 3 and 4, and
M¹ is in each case the same or different and is a transition metal of group 3 to 12 of the Periodic Table of the Elements, preferably chromium, molybdenum, ruthenium, iron, rhodium, nickel, palladium or copper, more preferably iron or ruthenium, and
X² is in each case the same or different and is oxygen or a halogen atom, more preferably fluorine, chlorine, bromine or iodine, and
L is in each case the same or different and is a ligand, preferably a carbon ligand, for example methyl, phenyl, cymene, cumene, tolyl, mesityl, xylyl, indenyl benzylidene, cyclopentadienyl or carbonyl, a nitrogen ligand, for example triethylamine, tetramethylethylenediamine, pyridine, 2,2′-bipyridyl, substituted 2,2′-bipyridyl, 1,10-phenanthroline, phenylpyridin-2-ylmethylenamine, acetonitrile, substituted imidazolidine or terpyridyl, a phosphorus ligand, for example triphenylphosphine, tricyclohexylphosphine, bis(diphenylphosphino)-ethane, bis(diphenylphosphino)propane or BINAP, and
r is in each case the same or different and is a natural integer and is 1, 2, 3, 4 and 5, and
s is in each case the same or different and is a natural integer and is zero, 1, 2, 3, 4 and 5, and
t is in each case the same or different and is a natural integer and is zero, 1, 2, 3, 4 and 5, and
u is a natural integer and is 1, 2, 3, 4 and 5, and
M² is the same or different and is an element of group 1 to 15 of the Periodic Table of the Elements, more preferably Li, Mg, Ti, B, Al, P or N, and
R⁶ is the same or different and is hydrogen, a halogen atom or a C₁-C₂₀ group, more preferably methoxy, ethoxy, n-propoxy or i-propoxy, and
v is the same or different and is a natural integer and is 1, 2, 3, 4, 5, 6, 7 and 8, and
w is the same or different and is a natural integer and is 1, 2, 3, 4, 5, 6, 7 and 8, and
x is a natural integer and is 1, 2, 3, 4, 5, 6, 7 and 8.

7. The initiator system as claimed in claim 6 claim 5, characterized in that it, instead of the compound of the formula I comprise, at least one compound of the formula IV formula IV 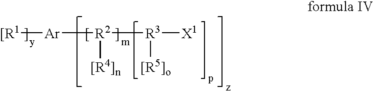
where
Ar is an aromatic basic structure having at least four carbon atoms, in which one or more carbon atoms may be exchanged for boron, nitrogen or phosphorus, preferred aromatic or heteroaromatic basic structures being derived from benzene, biphenyl, naphthalene, anthracene, phenanthrene, triphenylene, quinoline, pyridine, bipyridine, pyridazine, pyrimidine, pyrazine, triazine, benzopyrrole, benzotriazole, benzopyridine, benzopyrazidine, benzopyrimidine, benzopyrazine, benzotriazine, indolizine, quinolizine, carbazole, acridine, phenazine, benzoquinoline, phenoxazine, each of which may also optionally be substituted, and
R¹, R², R³, R⁴, R⁵ are each as defined in claim 6, and
m, n, o, p are each as defined in claim 6, and
X¹ is as defined in claim 6, and
y is a natural integer and is zero, 1, 2, 3, 4, 5, 6, 7, 8, 9, 10, 11, 12, 13, 14, 15, 16, 17, 18, 19 and 20, and
z is a natural integer and is 2, 3, 4, 5, 6, 7, 8, 9 and 10.

8. The initiator system as claimed in claim 6, characterized in that it, instead of the compound of the formula I comprise, at least one compound of the formula V: 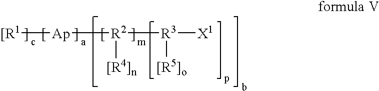
where
Ap is a cyclic nonaromatic basic structure having at least three carbon atoms which may also contain heteroatoms such as nitrogen, boron, phosphorus, oxygen or sulfur, preferred aliphatic basic structures being derivable from the group of cycloalkyl, for example cyclopropyl, cyclobutyl, cyclopentyl, cyclohexyl, cycloheptyl, cyclooctyl, cyclononyl, or from the cycloheteralkyl group, for example aziridine, azetidine, pyrrolidine, piperidine, azepane, azocane, 1,3,5-triazinane, 1,3,5-trioxane, oxetane, furan, dihydrofuran, Tetrahydrofuran, pyran, dihydropyran, tetrahydropyran, oxepane, oxocane, or from the group of the saccharides, for example alpha-glucose, beta-glucose, and
R¹, R², R³, R⁴, R⁵ are each as defined in claim 6, and
m, n, o, p are each as defined in claim 6, and
X¹ is as defined in claim 6, and
a is a natural integer and is zero, 1, 2, 3, 4, 5, 6, 7, 8, 9, 10, 11, 12, 13, 14, 15, 16, 17, 18, 19 and 20, and
b is a natural integer and is 2, 3, 4, 5, 6, 7, 8, 9 and 10, and
c is a natural integer and is zero, 1, 2, 3, 4, 5, 6, 7, 8, 9, 10, 11, 12, 13, 14, 15, 16, 17, 18, 19 and 20.

9. The use of one or more of the initiator systems as claimed in claim 6, 7, or 8 for preparing the polymers as claimed in claim 1.

10. A process for preparing the polymers as claimed in claim 1, characterized in that one or more of the initiator systems as claimed in claim 6, 7, or 8 is used.
